(19) United States
(12) Patent Application Publication
(10) Pub. No.: US 2017/0189993 A1
(43) Pub. Date: Jul. 6, 2017

(54) NOZZLE FOR LASER CUTTING WITH AN INTERNAL MOVEABLE ELEMENT AND A SLEEVE WITH LOW RELATIVE PERMITTIVITY

(71) Applicant: L'Air Liquide, Société Anonyme pour I'Etude et I'Exploitation des procédés Georges Claude, Paris (FR)

(72) Inventor: Philippe LEFEBVFRE, Meulan (FR)

(21) Appl. No.: 15/308,666

(22) PCT Filed: Apr. 22, 2015
(86) PCT No.: PCT/FR2015/051090

§ 371 Date: Nov. 3, 2016

(30) Foreign Application Priority Data
May 6, 2014 (FR) 1454093

(51) Int. Cl. B23K 26/14; B23K 37/00; B23K 26/38

(52) U.S. Cl. CPC B23K 26/1476; B23K 26/14; B23K 26/38; B23K 37/006; B23K 26/1462; B23K 26/1488

(57) ABSTRACT

A laser-cutting nozzle including a nozzle body including a first axial recess extending axially through the nozzle body, an inlet for supplying assist gas to the first axial recess and a first outlet located at a front surface of the nozzle body, and a moveable element arranged in the first axial recess of the nozzle body is provided.

### CROSS REFERENCE TO RELATED APPLICATIONS

This application is a 371 of International PCT Application PCT/FR2015/051090, filed Apr. 22, 2015, which claims priority to French Patent Application No. 1454093, filed May 6, 2014, the entire contents of which are incorporated herein by reference.

### BACKGROUND

The invention concerns a laser nozzle useable in laser cutting with an internal moveable element including a skirt making it possible to concentrate the gas in the cut, the nozzle offering improved use on an industrial scale and making it possible to protect the focusing head from the effects of impacts that said nozzle may suffer.

Laser beam cutting necessitates the use of a nozzle, generally made of copper, the effect of which is to channel the gas and to allow the laser beam to pass through.

The nozzles typically have outlet orifice diameters between 0.5 and 3 mm inclusive for a working distance between 0.6 and 2 mm inclusive.

In order to make cutting possible, it is necessary to use high pressures, generally of several bar, in the focusing head in order to make it possible for the gas to enter the cut to expel the molten metal.

Now, a large amount of the gas used, typically between 50 and 90%, has no action on the cutting process, i.e. on the expulsion of the molten metal, because it is outside the cut.

These losses of gas are in fact caused by the enormous difference between the flow section of the nozzle orifice and the size of the focal spot. For example, the flow section of a nozzle with an outlet orifice diameter equal to 1.5 mm is 25 times greater than the section of the focal spot created by the laser beam passing through the nozzle.

Now, if an insufficient proportion of gas is used, cutting defects then occur, in particular adhering burrs and/or traces of oxidation.

Attempting to remedy this by reducing the diameter of the orifice of the nozzle is not ideal because this runs the risk of the laser beam striking the interior of the nozzle and damaging it, which moreover degrades the quality of cutting and/or performance.

There moreover exist a number of documents proposing various solutions that attempt to favor the entry of the gas into the cut, for example EP-A-1669159, JP-A-62006790, JP-A-61037393, JP-A-63108992, JP-A-63040695 and U.S. Pat. No. 4,031,351.

Now, none of those solutions is truly ideal because their architecture is often complex to implement, they are incompatible with industrial use, and/or they are of limited efficacy.

In particular, the document U.S. Pat. No. 4,031,351 discloses a laser cutting nozzle including a moveable element the end of which is pressed by a spring against the surface of the part to be cut to favor the injection of the cutting gas into the cut. The major drawback of this solution is that the force exerted by the spring in the direction of the plate, combined with the pressure of the cutting gas, leads to the moveable element exerting a high force on the plate to be cut. This leads to a risk of deformation, scoring or even entrainment of the plate, which is generally simply placed on the table of the industrial cutting machine.

To remedy this, the document WO-A-2012/156608 proposes a laser nozzle with a moveable element adapted to be moved axially in the nozzle body by the effect of a gas pressure and in the direction of the surface of the plate to be cut, until it comes into contact with the plate. The nozzle further includes an elastic element exerting an elastic return force on the moveable element in a direction tending to move it away from the plate. Accordingly, when the gas is shut off, the moveable element can be withdrawn into its rest position and the skirt can therefore enter the nozzle body.

This solution continues to give rise to certain problems, however.

Firstly, the design of this nozzle leaves little freedom for adapting its geometry to the various commercially available focusing heads and to the various thicknesses to be cut.

Now, the inventor of the present invention has shown that cutting small thicknesses, typically less than 3 mm, necessitates assist gas ejection orifices of greater diameter than the maximum diameters accessible with the nozzle according to WO-A-2012/156608. In fact, the maximum diameter of the axial housing machined in the nozzle body to receive therein the moveable element is imposed by the diameter of the upper part of the nozzle that connects to the focusing head. Because of this, the outlet orifice of the moveable element can be enlarged only to a certain degree, typically up to 2 mm, which does not make it possible to achieve satisfactory cutting performance on small thicknesses.

Moreover, industrial laser cutting machines and the associated focusing heads employ a capacitive distance sensor system, in a manner known in itself, in order to move the head at a constant distance above the plate to be cut.

Now, present-day capacitive sensor systems prove not to be able to detect a lateral obstacle extending over the surface of the plate. Such an obstacle may for example be the result of parts already cut out remaining jammed in the plate and positioned at an angle relative to its surface. Cuts starting from an edge of the plate can also generate steps or unevenness, i.e. differences of level between different portions of the plate, because of a deformation or a lowering of some parts of the plate occurring during cutting.

This leads to risks of impacts at the level of the nozzle body that can damage the nozzle and degrade its operation, to the point of leading to it breaking or deteriorating completely. The most problematic aspect is that an impact in the nozzle body can also damage the focusing head at the level of its connection to the nozzle and lead to a movement of the head on its support, which causes misalignment of the laser beam. It is then necessary to intervene on the focusing head and to realign it, which compromises the productivity of the cutting machine.

The document JP-A-2011-177727 discloses a nozzle body formed in two parts so as to avoid damaging the focusing head in the event of a collision with an obstacle.

However, this does not solve some of the problems encountered with the nozzle according to WO-A-2012/156608 in the context of industrial use.

Thus a capacitive distance sensor system employs the capacitive effect to detect small variations in distance between two conductive elements forming a capacitor. The distance separating the two conductive elements is determined by measuring the electrical capacitance of that capacitor, which notably depends on the dielectric permittivity of the medium that separates them.

In a cutting machine fitted with a conventional laser nozzle, generally formed of an electrically conductive material such as copper, the capacitive sensor measures the electrical capacitance between the plate and the flat surface of the nozzle facing the plate. The capacitive sensor is electrically connected to the devices controlling the movement of the focusing head so as to adjust the position of the head in terms of height in the event of variations of the measured electrical capacitances, or to stop the movement of the head in the event of contact between the nozzle and the plate.

This capacitive sensor system makes it possible to ensure constant cutting performance in terms of cutting quality and speed by maintaining the focusing point of the laser beam at a constant position relative to the surface of the plate. It also makes it possible to trigger the stopping of the machine if there are obstacles present on the plate.

It is therefore essential not to interfere with its operation.

Now, the laser nozzle described in WO-A-2012/156608 is hardly compatible with a system of this kind.

In fact, the moveable element of the nozzle forms a skirt in contact with the plate to be cut. To guarantee its resistance to the heat given off by the cutting process and to splashed molten metal, the moveable element is generally formed of an electrically conductive material such as a metal (copper, brass or the like).

However, the electrically conductive moveable element is then both in contact with the plate, i.e. at the same electrical potential as the latter, and in contact with the internal walls of the nozzle body, itself also generally formed of an electrically conductive material. It is therefore necessary to deactivate the capacitive sensor to prevent the cutting machine from malfunctioning.

One solution that would allow the capacitive sensor of the machine to function would be to use a movable element formed of an electrically insulative material. However, this solution is not ideal because electrically insulative materials are generally not highly resistant to the high level of heat given off by the cutting process, splashes of molten metal and/or thermal shock.

The problem faced is then palliating some or all of the drawbacks referred to above, notably by proposing a laser nozzle the ruggedness, service life and use of which on an industrial scale are greatly improved compared to the existing solutions and do not interfere with, or clearly interfere less than in the prior art with, the operation of a capacitive distance sensor system equipping an industrial cutting machine.

### SUMMARY

The solution according to the present invention is a laser cutting nozzle including a nozzle body including a first axial housing extending axially through said nozzle body, an inlet for supplying assist gas to said first axial housing and a first outlet located at a front surface of said nozzle body, and
a moveable element arranged in the first axial housing of the nozzle body, said movable element including a skirt-forming front portion and an axial passage with a second outlet orifice in said skirt-forming front portion,

the nozzle body and the moveable element being made of an electrically conductive material,

characterized in that
the nozzle body is made of at least one first portion arranged about the moveable element and one second portion that positions itself, according to the direction of flow of the assist gas in the first axial housing, above the said first portion, the nozzle body further including first attachment means adapted and designed to attach the second portion onto the first portion, and
a separator sleeve is arranged between the first portion and the moveable element, said separator sleeve being made of an electrically insulative material having a relative permittivity of less than 8.

As appropriate, the nozzle according to the invention may have one or more of the following technical features:
the separator sleeve is formed of an electrically insulative material having a relative permittivity of less than 6.
the separator sleeve is made of an electrically insulative ceramic material, for example of the Al₂O₃, AlN, ZrO₂ or Al₂TiO₅ type, a polymer material, for example polyetheretherketone (peek) or Vesper), electrically insulative ceramic or pyrex.
the separator sleeve is formed of a material chosen from: ceramic foams such as alumina foam or porous alumina, vitroceramics, for example Macor®, or technical ceramics such as boron nitride, mullite, steatite, cordierite.
the ceramic material is boron nitride.
the separator sleeve includes a second axial housing including a third outlet orifice situated at the level of a front face of said separator sleeve, the moveable element being arranged in said second axial housing and said third outlet orifice discharging above said second outlet orifice of the axial passage of the moveable element when the front portion projects out of the first axial housing.
the first attachment means extend through at least part of the first and second portions of the nozzle body and in a direction generally parallel to the axis of the first axial housing.
the second portion of the nozzle body includes second attachment means adapted and designed to fix said second portion to a laser focusing head.
the first and second attachment means are adapted and designed to fix the second portion of the nozzle body to the laser focusing head more firmly than to the first portion so that in the event of an impact in the first portion of the nozzle body the nozzle body is deformed or breaks essentially between the first portion of the nozzle body and the second portion.
the moveable element is adapted and designed to move in translation in the first axial housing in the direction of the first outlet orifice until the front portion projects out of said first axial housing through the first outlet orifice.
the moveable element is adapted to be moved in translation in the first axial housing in the direction of the first outlet orifice by the effect of a gas pressure in the first axial housing and exerted on the moveable element.
the nozzle further includes an elastic element in the first axial housing between the nozzle body and the moveable element, said elastic element exerting an elastic return force on the moveable element tending to oppose the movement in translation in the first axial housing in the direction of the first outlet orifice.
the moveable element is adapted to be moved between a plurality of positions including:
a rest position in which the front portion of the moveable element is completely or virtually completely withdrawn into the axial housing, and
a working position in which the skirt of the front portion of the moveable element projects completely or virtually completely outside the axial housing through the first outlet orifice.
there is at least one sealing element between the nozzle body and the moveable element, for example one or more O-rings.
said at least one sealing element is arranged in a peripheral groove in the external peripheral wall of the moveable element.
the axial passage of the moveable element has a profile of conical, frustoconical or convergent/divergent shape.
the nozzle body is advantageously made of a metal, such as steel, bronze, refractory steel, copper, brass, or an electrically conductive ceramic material.
the moveable element is advantageously made of a metal, such as steel, bronze, refractory steel, copper, brass, or an electrically conductive ceramic material. The moveable element is preferably made of an electrically conductive material that induces limited friction on the plate to limit wear of the plate. The moveable element is advantageously formed of a bronze alloy containing lead.

The invention also relates to a laser focusing head including at least one focusing optic, for example one or more lenses or mirrors, notably a focusing lens and a collimating lens, characterized in that it further includes a laser cutting nozzle according to the invention.

Moreover, the invention also concerns a laser installation including a laser generator, a laser focusing head and a laser beam conveying device connected to said laser generator and to said laser focusing head, characterized in that the laser focusing head is one according to the invention.

The laser source or generator is preferably of CO₂, YAG, fiber or disk type, preferably fiber or disk type, notably a laser source with ytterbium fibers.

According to a further aspect, the invention also relates to a method of cutting a metal part using a laser beam and a nozzle, a laser focusing head or an installation according to the invention.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1A is a diagram of a focusing head of a conventional laser cutting installation,

FIG. 1B is a diagram showing the size of the laser spot relative to the size of the nozzle orifice,

FIG. 2 is a diagrammatic sectional view of the body of a nozzle according to one embodiment of the invention, with no moveable element arranged therein,

FIG. 3 is a diagrammatic sectional view of a nozzle according to one embodiment of the invention, and

FIGS. 4A and 4B show the nozzle according to the invention with the moveable element in two different positions.

### DESCRIPTION OF PREFERRED EMBODIMENTS

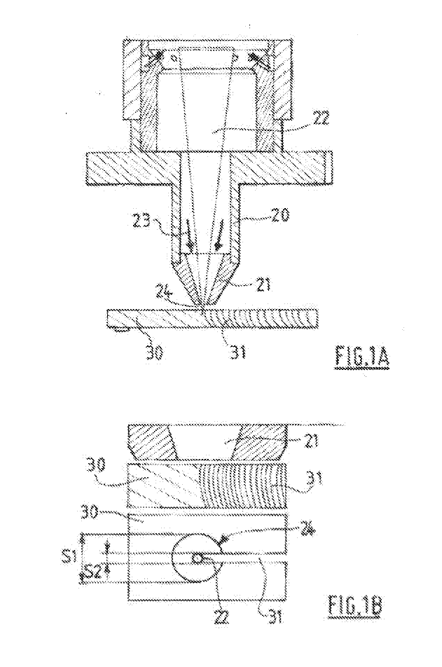

FIG. 1A represents the focusing head 20 of a conventional laser cutting installation, to which is fixed a conventional laser nozzle 21 through which passes a focused laser beam and an assist gas (arrow 23) used to expel the metal melted by the beam out of the cut 31 formed by the beam 22 in the metal part 30 to be cut, for example a steel or stainless steel plate.

The assist gas may be an active gas, such as oxygen, air, CO₂, hydrogen, or an inert gas, such as argon, nitrogen, helium, or a mixture of these active and/or inert gases. The composition of the gas is notably chosen as a function of the nature of the part to be cut.

The beam that impacts on the part melts the metal thereof that will be expelled under the part by the pressure of the assist gas.

FIG. 1B shows clearly the flow section S1 of the orifice 24 of the nozzle 21 relative to the size S2 of the focal spot of the beam 22. As can be seen, the section 51 is very much larger than the size S2 of the focal spot of the beam 22, which in conventional nozzles generates a high consumption of assist gas, only a small proportion of which serves to expel the molten metal out of the cut 31.

To reduce considerably the consumption of gas and the pressure needed for cutting, there is proposed in the document WO-A-2012/156608 a laser nozzle adapted and designed to cut with a laser beam using a lower gas flow rate and/or a lower gas pressure thanks to a particular nozzle architecture making it possible to force a greater proportion of gas to enter the cut 31 and expel the molten metal therefrom effectively.

According to WO-A-2012/156608, the laser nozzle includes a nozzle body 1 cooperating with a moveable element 2 arranged and mobile inside the body 1 of the nozzle.

However, the construction of this laser nozzle is not ideal, for the reasons already referred to.

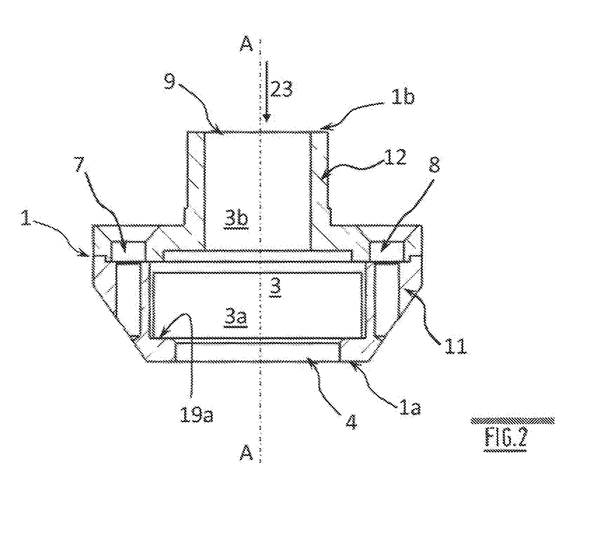

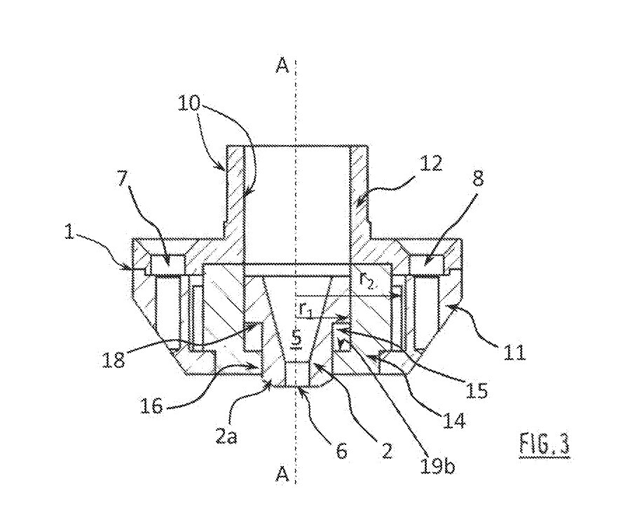

To remedy this, and as shown in FIGS. 2 and 3, the present invention proposes a laser nozzle including a moveable element 2 and a body 1 formed of at least a first portion 11 that is arranged around the moveable element 2 and a second portion 12 that is positioned above said first portion 11 in the direction of flow of the assist gas (arrow 23). The nozzle body 1 further includes first attachment means 7, 8 adapted and designed to attach the second portion 12 to the first portion 11.

In fact, when assembling the nozzle, the moveable element 2 is first arranged inside the first portion 11. The second portion 12 is then superposed on and attached to the first portion 11 of the nozzle body 1. It is therefore possible to retain a second portion 12 the geometry of which is suited to the focusing head to which the nozzle body 1 has to be fixed, as well as increasing the volume available inside the first portion 11 to accommodate the moveable element 2.

It is then possible to enlarge the axial passage 5 and the outlet orifice 6 of the moveable element 2, and the diameter of the outlet orifice 6 can typically be up to 10 mm and is preferably 6 mm. This makes it possible to enlarge the gas coverage of the cut and to prevent the phenomena of oxidation of the cut faces that can occur at high cutting speeds achieved on small thickness of plate, typically from 3 to 30 m/min for thicknesses of less than 3 mm, and in particular when cutting stainless steel using nitrogen as the assist gas 23.

Moreover, the nozzle according to the invention makes it possible to protect the focusing head from the harmful effects of possible obstacles on the plate. In fact, if there is an obstacle on the surface of the plate, it is essentially at the level of the first portion 11 of the nozzle body 1, positioned immediately above the plate, that the impact occurs. Constructing the nozzle body 1 from a plurality of parts assembled together, and not in one piece, offers some flexibility in movement of the first portion 11 relative to the second portion 12 and/or a possibility of breaking the connection between the first portion 11 and the second portion 12. In the event of an impact, this makes it possible to minimize the risks of movement of the second portion 12 relative to the focusing head and/or of the focusing head relative to its support.

The nozzle body 1 is advantageously a circular part through which passes completely a first axial housing 3 with axis AA that extends from the rear face 1b of the body 1 to the front face 1a of said body 1.

The first axial housing 3 opens onto both the front face 1a and the rear face 1b of the nozzle body 1. The rear face 1b includes an inlet orifice 9 and the front face 1a includes a first outlet orifice 4 of the nozzle body 1, the first inlet orifice 9 and the first outlet orifice 4 being coaxial with the axis AA.

This first axial housing 3 is in fact a recess formed of a second portion 3b extending through the second portion 12 and a first portion 3a extending through the first portion 11. The first and second portions 3a, 3b are preferably of cylindrical shape, the first portion 3a including a first internal shoulder 19a projecting radially toward the center of the first housing 3, said first internal shoulder 19a being formed by a constriction in the section of the first axial housing 3 at the level of the first outlet orifice 4. The first internal shoulder 19a is preferably at the level of the bottom of said first axial housing 3.

The nozzle further includes a moveable element 2 that is inserted in the first housing 3 of the nozzle body 1, preferably coaxially with the body 1, as can be seen in FIG. 3. The moveable element 2 includes a front portion 2a forming a skirt of cylindrical, i.e. tubular, shape, and an axial passage 5 with a second outlet orifice 6 discharging at the level of said front portion 2a forming the skirt.

The axial passage 5 may have a conical internal profile, with cylindrical or non-cylindrical outlet channel, frustoconical, of convergent/divergent type (i.e. de Laval nozzle) or any other appropriate geometry.

In the context of the invention, the moveable element (2) is made of an electrically conductive material. In fact, the moveable element is situated in the immediate vicinity of the cutting area and this type of material offers a higher resistance to high temperatures and to shock (impacts of the moveable element on the plate) and/or thermal shock (turning the laser on and off). For example, the moveable element 2 may be made of steel, hardened steel, carbon, a composite material, etc.

A conductive material will preferably be chosen that induces limited friction on the plate to limit wear of the plate, i.e. a material that is not abrasive or not very abrasive.

The moveable element 2 is advantageously formed of a bronze alloy containing lead. In fact, a material of this kind offers the advantage of having good friction properties, good resistance to wear under high loads and good resistance to corrosion. Its use is particularly advantageous under difficult conditions of lubrication because of its self-lubricating property. This greatly reduces or even eliminates the risk of scoring or entraining the plate when the moveable element is in contact with its surface.

It is to be noted that in the context of the present invention, by electrically insulative material, or dielectric material, is meant a material that does not conduct electricity, i.e. that blocks the passage of electric current between two electrically conductive elements. Conversely, an electrically conductive material contains numerous electrical charge carriers that can easily be moved by the action of an electromagnetic field.

The nozzle body (1) is made of an electrically conductive material. In other words, the first and second portions 11, 12 of the nozzle body 1 are made of an electrically conductive material. This material can be a metal, for example steel, bronze, refractory steel, copper or brass, or an electrically-conductive ceramic material.

Using a conductive material for the first and second portions 11, 12 of the nozzle body 1 is advantageous because it allows the use of a capacitive sensor system. In fact, in use, the nozzle body 1 is mounted at the end of a focusing head 20 including a capacitive sensor system known in itself. This system uses the capacitive effect to detect small variations of distance between two conductive elements forming a capacitor. The distance separating the two conductive elements is determined by measuring the electrical capacitance of this capacitor, which notably depends on the dielectric permittivity of the material that separates them.

Conventional laser nozzles are generally made of an electrically conductive material such as copper. When the nozzle is mounted at the end of the head, it is electrically connected to the capacitive sensor system. As a result, the capacitive sensor is able to measure the electrical capacitance between the plate and the plane surface of the nozzle facing the plate. The capacitive sensor is itself electrically connected to the devices controlling movements of the focusing head 20 so as to adjust the heightwise position of the head in the event of variations in the measured capacitance.

When the laser nozzle according to the invention is assembled to the focusing head, the conductive material nozzle body 1 can therefore be electrically connected to the capacitive sensor system with which the head is equipped. This electrical connection is advantageously made by contact of at least a portion of the second portion 12 of the body 1 with a component of the head 20 made of an electrically conductive material and forming part of the capacitive sensor system.

When the electrically conductive moveable element 2 comes into contact with the plate, it is at the same electrical potential as the latter.

Consequently, the nozzle according to the invention includes a separator sleeve 14 between the first portion 11 and the moveable element 2 and formed of an electrically conductive material.

This makes it possible to avoid causing a malfunction of the capacitive sensor or interfering with its operation.

In fact, the capacitive sensor then measures one or more electrical capacitance values between the front face 1a of the nozzle body 1 and the upper surface of the part 30 to be cut. Based on these values, the sensor makes it possible to adjust the distance between the nose cone and the plate to a constant or quasi-constant value, typically between 0.1 and 5 mm, preferably between 0.5 and 2 mm, and to correct defects in terms of the flatness of the plate.

In the context of the present invention, a separator sleeve 14 is used that is formed of a material having a low permittivity.

In fact, in the case of a standard laser nozzle, i.e. one with no moveable element, the capacitance is measured between two plane surfaces facing each other, i.e. the front face of the nozzle body and the upper surface of the part to be cut. In this case, the capacitance C (in pF/m) is given by the following formula:

$$C = {ɛ}_{0} {ɛ}_{r} \times \frac{S}{d}$$

where ∈₀ is the permittivity of a vacuum, equal to 8.85 pF/m, ∈ᵣ is the relative permittivity of the material separating the front face of the nozzle body and the upper surface of the part to be cut, having a value of 1.004 in the case of air, S is the nozzle area facing the plate to be cut (expressed in m²), and d is the distance between the front face of the nozzle body and the upper surface of the part to be cut (expressed in m).

In the case of a laser nozzle according to the invention with a moveable element, the capacitive sensor system in fact carries out two types of capacitance measurement. Before the moveable element comes into contact with the upper surface of the plate, the sensor carries out a first measurement between two plane surfaces, i.e. the front face of the nozzle body and the upper surface of the part to be cut. This measurement is a reference measurement making it possible to maintain the nozzle body 1 at the required height relative to the part to be cut. Once the moveable element 2 is in contact with the part to carry out the cutting operation proper, the latter is at the same potential as the part. The sensor then carries out, in addition to the first capacitance measurement, a measurement of the overall capacitance resulting from a multitude of measurements taken between the exterior surface of the moveable element 2 and the interior surface of the first portion 11 of the body. In fact, the distance between these surfaces varies according to the position concerned along the axis AA of the nozzle.

At a given point along the axis AA of the nozzle, the capacitance C is expressed (in pF/m) by the following formula:

$$C = 2 {πɛ}_{0} {ɛ}_{r} \times \frac{l}{ln \frac{{r}_{2}}{{r}_{1}}}$$

in which r₂ is the radius of the first axial housing 3, r₁ is the radius of the moveable element 2 at the point concerned (see FIG. 3) and l is the distance (expressed in m) along the axis AA over which the first axial housing 3 and the moveable element 2 have the respective radii r₂ and r₁.

Now, the inventor of the present invention has shown that the use of a separator sleeve 14 formed of a material of low relative permittivity made it possible to improve the stability of the capacitive sensor by reducing the interference caused by the overall capacitance measurements, in addition to the first or reference measurement. It is therefore possible during cutting to preserve a position of the nozzle body 1 at a height very close to or even identical to the reference height before starting cutting.

By material of low relative permittivity is meant a material the relative permittivity of which is less than 8, preferably less than 6.

The thickness at any point on the peripheral wall of the separator sleeve 14 is advantageously at least 0.5 mm, preferably at least 1 mm, and advantageously between 0.5 and 10 mm inclusive, preferably between 1 and 3 mm inclusive.

There will advantageously also be chosen a material resistant to temperatures of the order of 100 to 2000° C., typically between 500 and 1500° C.

According to one particular embodiment, the exterior dimensions of the separator sleeve 14 are chosen so as to leave a gap between the first portion 11 of the nozzle body 1 and the moveable element 2. This gap filled with air makes it possible to reduce even further the harmful influence of the overall capacitance measurement on the stability of the heightwise position of the nozzle body 1.

The separator sleeve 14 is preferably made of a material chosen from: ceramic foams such as alumina foam or porous alumina, vitroceramics, for example Macor®, or technical ceramics such as boron nitride, mullite, steatite or cordierite. Table 1 below shows ranges of values of relative permittivity of the aforementioned materials, which can vary according to the grades of materials selected and the types of fabrication processes used.

The use of a ceramic material, such as boron nitride, is particularly advantageous because of its high resistance to high temperatures and thermal shock and wear. In particular boron nitride offers excellent machineability.

TABLE 1

| Ceramic type | Relative permittivity range |
|---|---|
| Porous alumina | 1.7-1.9 |
| Macor ® | 5.6-6.1 |
| Boron nitride | 4-5 |
| Mullite | 5.5-6.5 |
| Steatite | 5.7-6.2 |
| Cordierite | 4.8-5.2 |

The separator sleeve 14 advantageously includes a second axial housing 15 including a third outlet orifice 16 situated in a front face 14a of said separator sleeve 14, the moveable element 2 being arranged in said second axial housing 15 and said third outlet orifice 16 discharging above said second outlet orifice 6 of the axial passage 5 of the moveable element 2 when the front portion 2a projects outside the first axial housing 3. The second axial housing 15 advantageously includes a second internal shoulder 19b projecting radially toward the center of said second housing 15 and preferably situated at the far end of said second housing 15.

The peripheral wall of the moveable element 2 advantageously includes a first abutment 18 on the external surface. The first abutment 10 is preferably of annular shape and extends around all or part of the periphery of the moveable element 2. Depending on whether the nozzle includes an intermediate sleeve 14 or not, the first abutment 18 is arranged facing the first shoulder 19a of the nozzle body 1 or the second shoulder 19b of the sleeve 14.

As shown diagrammatically in FIGS. 2 and 3, the first attachment means 7, 8 make it possible to attach the second portion 12 of the nozzle body 1 to the first portion 11 advantageously extending through at least part of the first and second portions of the nozzle body 1 and in a direction generally parallel to the axis AA of the first axial housing 3. An arrangement of this kind makes it possible to reduce the overall size of the nozzle body 1 and moreover, in the event of a severe shock suffered by the first portion 11, promotes a clean break between the first portion 11 and the second portion 12.

The first attachment means 7, 8 can make possible removable or non-removable attachment of the first portion 11 of the nozzle body 1 to the second portion 12.

According to a preferred embodiment of the invention, the first attachment means 7, 8 include at least one first threaded hole passing at least partly through the first and second portions 11, 12 of the nozzle body 1 and a threaded cylindrical part (not shown) shaped to be screwed into said first threaded hole. FIGS. 2 and 3 illustrate an embodiment in which the first attachment means 7, 8 include two diametrically opposite threaded holes.

According to a variant embodiment, the first attachment means 7, 8 comprise clipping, bayonet-coupling or crimping means for attaching the first portion 11 to the second portion 12.

The second portion 12 of the nozzle body 1 preferably includes second attachment means 10 adapted and designed to attach said second portion 12 to the laser focusing head 20.

As shown in FIG. 3, the second portion 12 may therefore include an end portion of tubular shape, said end portion including a first thread 10 on the external surface of said end portion or a first thread 10 on the internal surface of said end portion. The first internal or external thread 10 is shaped to be screwed into a second internal thread or onto a second external thread, respectively, of the laser focusing head 20 (not shown).

The first attachment means 7, 8 and the second attachment means 10 are advantageously adapted and designed to attach the second portion 12 of the nozzle body 1 to the laser focusing head 20 more firmly than to the second portion 11 so that, in the event of an impact on the first portion 11 of the nozzle body 1, the nozzle body 1 is deformed or breaks essentially between the first portion 11 and the second portion 12 of the nozzle body 1. This minimizes the risk of breakage or of deformation at the level of the focusing head 20, which avoids long maintenance operations at the level of the cutting installation.

According to one particular embodiment, this control of the firmness of the attachment of the second portion 12 to the focusing head 20 compared to the firmness of the attachment of the second portion 12 to the first portion 11 can be obtained by sizing the diameter and/or pitch of the internal or external threads of the first attachment means 7, 8 and the second attachment means 10. The first attachment means 7, 8 and the second attachment means 10 may also be quick-action attachment means, in particular clicking or clipping, crimping or bayonet-coupling type attachment means.

When using the nozzle, the laser beam 22 and the assist gas 23 pass through the axial passage 5 of the moveable element 2 and exit via the second outlet orifice 6 discharging on the front portion 2a forming the skirt.

The moveable element 2 is advantageously moveable in translation along the axis AA in the first axial housing 3 in the direction of the first outlet orifice 4 until the front portion 2a projects outside said first axial housing 3 through the first outlet orifice 4.

The moveable element 2 is preferably moved by the pressure of the assist gas 23 that is exerted on said moveable element 2, which tends to push it in the direction of the part 30 to be cut.

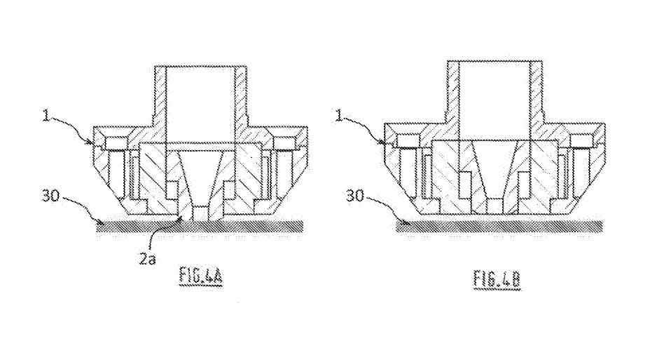

The movement in translation of the moveable element 2 along the axis AA will cause the skirt to move toward the upper surface 30 of the plate to be cut, and they will come into contact with each other, as shown in FIG. 4B. The gas will therefore be channeled by the skirt and concentrated at the level of the laser spot and therefore the cut, which will greatly enhance its effectiveness in the expulsion of the metal melted by the laser beam 22.

An elastic element 17, such as a spring, is advantageously arranged in the first axial housing 3 between the nozzle body 1 and the moveable element 2 or in the second axial housing 15 between the separator sleeve 14 and the moveable element 2. To be more precise, the elastic element exerts an elastic return force on the moveable element 2 in a direction tending to move it away from the part 30 to be cut. At the end of cutting, when the gas is shut off and the gas pressure ceases to be exerted on the moveable element 2, the latter can therefore be returned into its rest position and the skirt re-enter the first housing 3. The elastic element 17 is advantageously arranged between the first abutment 18 and the first shoulder 19a of the nozzle body 1 or the second shoulder 19b of the sleeve 14 according to whether there is a sleeve in the first axial housing 3 or not.

The elastic element 17 therefore makes it possible to limit the phenomenon of wear of the skirt during phases of piercing the plate that generally precede the cutting phase. In fact piercing is most often performed with low gas pressures, typically less than 4 bar. The elastic element then exerts a sufficient return force for the skirt to return completely or virtually completely into the first housing 3 so that it is protected from splashing by the molten metal generated by piercing.

Moreover, the elastic element 17 facilitates rapid movement of the cutting head at a small distance above the plate with no cutting gas or beam since the gas pressure then ceases to be exerted on the moveable element and the skirt re-enters the first housing 3. Only the skirt rises and it is not necessary to raise the focusing head supporting the nozzle.

The elastic element 1 also makes it possible to limit the pressure exerted by the moveable element 2 on the part to be cut when the latter is moved in the direction of the part by the effect of the cutting gas. To be more precise, the return force of the elastic element 8 is advantageously determined to hold the moveable element 2 in contact with the part to be cut at the same time as limiting the pressure that said element exerts on the plate, to minimize or even eliminate all risk of deformation of the plate from which the part is cut, scoring of the surface of the plate and entrainment of the plate.

As appropriate, the moveable element 2 may include a front portion 2a of cylindrical shape, i.e. of constant outside diameter along the axis AA, or an end portion shaped to pass over an unevenness or an obstacle with no impact or greatly reduced impact on the skirt 6.

The front portion 2a advantageously includes an end portion the outside diameter of which decreases progressively in the direction of the second outlet orifice 12. As a result, the front portion 2a is shaped to facilitate its passage over raised areas or obstacles present on the surface of the plate. Impacts are better adsorbed because the progressive reduction of the outside diameter of the end portion favors the rising of the skirt 6 toward the housing 5 if the skirt 6 encounters an unevenness or a localized obstacle.

By end portion is meant a portion of the front portion 2a situated at the end of said front portion, i.e. facing the upper surface of the plate to be cut.

At least one sealing element, for example an elastomer seal, is optionally arranged between the nozzle body 1 and the moveable element 2 or between the separator sleeve 14 and the moveable element 2, in particular one or more 0-rings, which makes it possible to provide a seal between the nozzle body 1 or the separator sleeve 14 and the moveable insert 2. Said sealing element is preferably arranged in a peripheral groove in the external peripheral wall of the moveable element 2.

In fact, the moveable element 2 of the nozzle according to the invention is able to move between a plurality of positions including at least:
a working position in which the front portion 2a projects completely or almost completely out of the first axial housing 3 of the nozzle body 1, via the first outlet orifice 4, and comes into contact with the part 30 to be cut, as shown in FIG. 4A, and
a rest position in which the front portion 2a is completely or virtually completely inside the first axial housing 3 of the nozzle body 1, as shown in FIG. 4B.

Of course, the moveable element 2 can occupy intermediate positions in which the front portion 2a projects only partly out of the first axial housing 3 of the nozzle body 1. These intermediate positions may notably be a function of the pressure exerted by the gas on the moveable element 2.

In order to demonstrate the efficacy of the nozzle according to the invention compared to a standard nozzle, i.e. a conventional nozzle with no moveable element, and therefore the benefit of forcing the gas into the cut thanks to the use of a skirt mounted on a moveable element, comparative tests have been carried out using a cutting installation with a CO₂ laser generating a laser beam that is fed to a laser focusing head including focusing optics, namely lenses.

### EXAMPLES

### Example 1

As appropriate, the laser focusing head is equipped with:
a standard nozzle with a 1.8 mm diameter outlet orifice, or
a nozzle according to FIG. 3 with a two-part body, cylindrical moveable skirt made of steel and axial passage of the skirt of conical profile with a cylindrical outlet channel of 1.8 mm diameter.

During this test, the capacitive sensor has the parameters set to adjust the distance between the front face of the nose cone and the upper surface of the plate to be cut to 1 mm.

The assist gas used is nitrogen.

The plate to be cut is made of 304L stainless steel 5 mm thick.

The laser beam has a power of 4 kW and the cutting speed is 2.6 m/min.

The results obtained demonstrated that:
with the standard nozzle, a gas pressure of 14 bar is insufficient to obtain a cut of quality. In fact, at 14 bar, the cut edges include numerous adhering burrs. This demonstrates that the evacuation of the molten metal is poor because of insufficient action of the gas on the molten metal to be expelled. In order to eliminate these burrs, a pressure of 16 bar was necessary.
with the nozzle of the invention, tests carried out at pressures ranging between 1 and 5 bar produce cuts of good quality, i.e. cut edges free of adhering burrs. The skirt of the nozzle makes it possible to channel the gas into the cut and to expel the molten metal effectively.

### Example 2

As appropriate, the laser focusing head is equipped with:
a standard nozzle (A) with a 1.5 mm diameter outlet orifice, or
a nozzle (B) with one-piece body according to the document WO-A-2012/156608, steel cylindrical moveable skirt and axial passage of the skirt of conical profile with cylindrical outlet channel of 2 mm diameter, or
a nozzle (C) according to FIG. 3 with two-part body, steel cylindrical moveable skirt and axial passage of the skirt of conical profile with a cylindrical outlet channel of 6 mm diameter.

During this test, the capacitive sensor has the parameters set to adjust the distance between the front face of the nose cone and the upper face of the plate to be cut to 1 mm.

The assist gas used is nitrogen.

The plate to be cut is made of 304L stainless steel 2 mm thick.

The laser beam has a power of 4 kW.

The table below sets out the cutting results obtained under the conditions of Example 2 with the three types of nozzle A, B, C referred to above, in terms of cutting speed, assist gas pressure used and presence or absence of burrs and/or of traces of oxidation on the cut faces.

These tests clearly demonstrate the efficacy of the nozzle C according to the invention, which makes it possible to reduce considerably the gas pressure to be used compared to a standard nozzle, all conditions otherwise being the same, and therefore also to reduce the consumption of gas. Moreover, the nozzle C according to the invention makes it possible to enlarge the diameter of the outlet orifice of the assist gas, which on small thicknesses makes it possible to increase the cutting speed without generating phenomena of oxidation of the cut faces, which was not possible with the prior art nozzle B with moveable skirt.

TABLE 2

| | | Outlet | | | |
|---|---|---|---|---|---|
| Nozzle | Material/ | orifice | | Cutting | Cut |
| type | Thickness | diameter | Pressure | speed | quality |
| A | 304 L steel/ | 1.5 mm | 15 bar | 6.7 m/min | Good, no |
| | 2 mm | | | | burrs or |
| | | | | | oxidation |
| B | 304 L steel/ | 2.0 mm | 7 bar | 6.7 m/min | No burrs |
| | 2 mm | | | | but cut |
| | | | | | faces |
| | | | | | oxidized |
| C | 304 L steel/ | 6.0 mm | 7 bar | 9.5 m/min | Good, no |
| (invention) | 2 mm | | | | burrs or |
| | | | | | oxidation |

1.-16. (canceled)

17. A laser cutting nozzle comprising:
a nozzle body comprising a first axial housing extending axially through the nozzle body, an inlet configured to supply assist gas to the first axial housing and a first outlet located at a front surface of the nozzle body, and
a moveable element arranged in the first axial housing of the nozzle body, wherein the movable element includes a skirt-forming front portion and an axial passage with a second outlet orifice in the skirt-forming front portion,
wherein the nozzle body and the moveable element are made of an electrically conductive material,
wherein
the nozzle body is made of at least one first portion arranged about the moveable element and one second portion that positions itself, according to the direction of flow of the assist gas in the first axial housing, above the first portion, wherein the nozzle body further comprises a first attachment means configured to attach the second portion onto the first portion, and
a separator sleeve arranged between the first portion and the moveable element and the separator sleeve is made of an electrically insulative material having a relative permittivity of less than 8.

18. The nozzle of claim 17, wherein the separator sleeve is formed of an electrically insulative material having a relative permittivity of less than 6.

19. The nozzle of claim 17, wherein the separator sleeve is formed of a ceramic material.

20. The nozzle as of claim 19, wherein the ceramic material is boron nitride.

21. The nozzle of claim 17, wherein the separator sleeve comprises a second axial housing comprising a third outlet orifice situated in a front face of the separator sleeve, the moveable element being arranged in the second axial housing and the third outlet orifice discharging above the second outlet orifice of the axial passage of the moveable element when the front portion projects out of the first axial housing.

22. The nozzle of claim 17, wherein the moveable element is formed of a brass alloy containing lead.

23. The nozzle of claim 17, wherein the first attachment means extends through at least part of the first and second portions of the nozzle body and in a direction generally parallel to the axis of the first axial housing.

24. The nozzle of claim 17, wherein the second portion of the nozzle body includes a second attachment means configured to to affix the second portion to a laser focusing head.

25. The nozzle of claim 17, wherein the first attachment means and the second attachment means are configured to affix the second portion of the nozzle body to the laser focusing head more firmly than to the first portion so that in the event of an impact in the first portion of the nozzle body the nozzle body is deformed or breaks essentially between the first portion of the nozzle body and the second portion.

26. The nozzle of claim 17, wherein the moveable element is configured to move in translation in the first axial housing in the direction of the first outlet orifice until the front portion projects out of the first axial housing through the first outlet orifice.

27. The nozzle of claim 17, wherein the moveable element is configured be moved in translation in the first axial housing in the direction of the first outlet orifice by the effect of a gas pressure in the first axial housing and exerted on the moveable element.

28. The nozzle of claim 17, further comprising an elastic element in the first axial housing between the nozzle body and the moveable element, the elastic element exerting an elastic return force on the moveable element tending to oppose the movement in translation in the first axial housing in the direction of the first outlet orifice.

29. The nozzle of claim 17, wherein the moveable element is configured to be moved between a plurality of positions including:
a rest position in which the front portion of the moveable element is completely or virtually completely withdrawn into the axial housing, and
a working position in which the skirt of the front portion of the moveable element projects completely or virtually completely outside the axial housing through the first outlet orifice.

30. A laser focusing head comprising at least one focusing optic, further comprising the laser cutting nozzle of claim 17.

31. A laser installation including a laser generator, a laser focusing head and a laser beam conveying device connected to the laser generator and to the laser focusing head, further comprising the laser focusing head of claim 16.
